(19) United States
(12) Patent Application Publication
(10) Pub. No.: US 2016/0290531 A1
(43) Pub. Date: Oct. 6, 2016

(54) CABLE RESTRAINT SYSTEM

(71) Applicant: Tektronix, Inc., Beaverton, OR (US)

(72) Inventors: Jessica A. Dunn, Beaverton, OR (US); Lawrence M. Le Mon, Beaverton, OR (US)

(21) Appl. No.: 14/674,281

(22) Filed: Mar. 31, 2015

(51) Int. Cl. F16L 3/10; F16L 3/26

(52) U.S. Cl. CPC F16L 3/10; F16L 3/26

(57) ABSTRACT

A cable restraint system including a device base. The device base includes a base plate, and at least one mounting post disposed thereon, and a cable restraint device. The cable restraint device includes a base portion having at least one mounting column structured to receive the at least one mounting post, a pair of opposed sidewalls defining a trough structured to receive at least one cable, a flexible insert received in the base portion and disposed between the sidewalls, and a top portion spanning the sidewalls to retain the flexible insert within the base portion and structured to engage the at least one mounting post.

### BACKGROUND

High frequency cables are required to sample signals in the gigahertz range while testing equipment and devices. These high frequency cables are fragile and easily damaged, which results in the sampled signal being degraded or disrupted. Therefore, the cables are treated with the utmost care to ensure that the cable is not kinked or damaged. As the cost of these cables can be in the hundreds of dollars, it is not economically viable to be constantly replacing damaged cables.

The high frequency cables may be affixed to test probes and connected to test equipment, but the transmitted signal must also be routed through the device itself using the same kind of high frequency cable. There exists a delicate balance between protecting the internal cable(s) and packaging the test equipment within a housing. The cable(s) may snake between the various internal components to reach a termination point that may be located a circuitous path away from the probe connection. The cables are routed carefully through the housing to avoid kinking and damaging the cable on its path through the device.

Embodiments of the disclosed technology address these needs.

### BRIEF DESCRIPTION OF THE DRAWINGS

FIG. 1 is an exploded perspective view of an embodiment of the cable restraint device.

FIG. 2 is a perspective view of the base plate used in conjunction with the cable restraint device of FIG. 1.

FIG. 3A is a top view of multiple cable restraint devices installed on a base plate.

FIG. 3B is a side view of the embodiment of FIG. 3A.

FIG. 4 is an enlarged perspective view of the base piece of the cable restraint device of FIG. 1.

FIG. 5 is a perspective view of the flexible pad of the cable restraint device of FIG. 1.

FIG. 6 is a perspective view of the top piece of the cable restraint device of FIG. 1.

FIGS. 7A and 7B illustrate an example cable restraint device attached to a device base integrated into a substrate.

FIGS. 8A and 8B illustrate an example cable restraint device having a single top portion.

FIGS. 9A and 9B illustrate an example cable restraint device and device base mounted in a housing.

### DETAILED DESCRIPTION

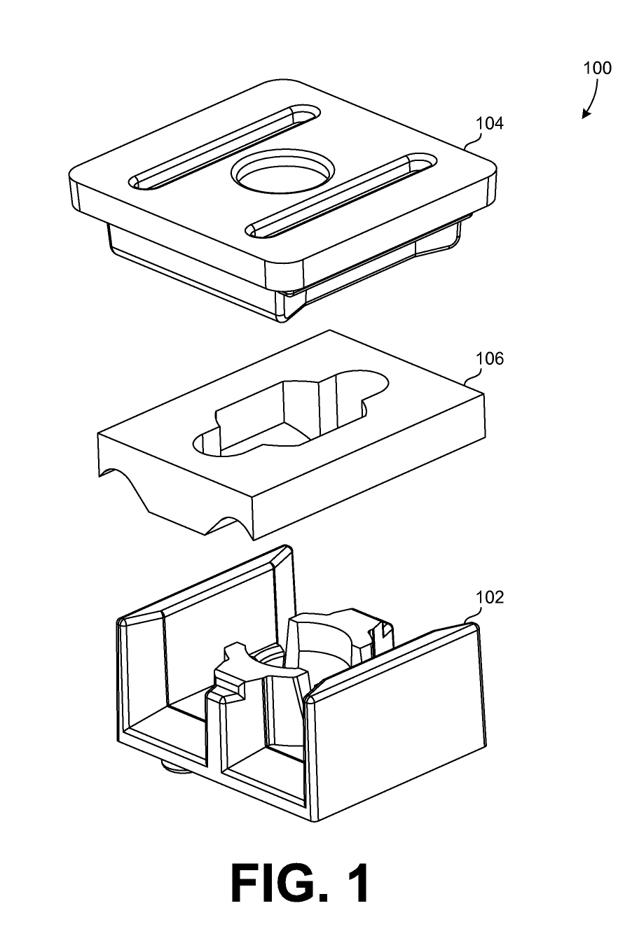

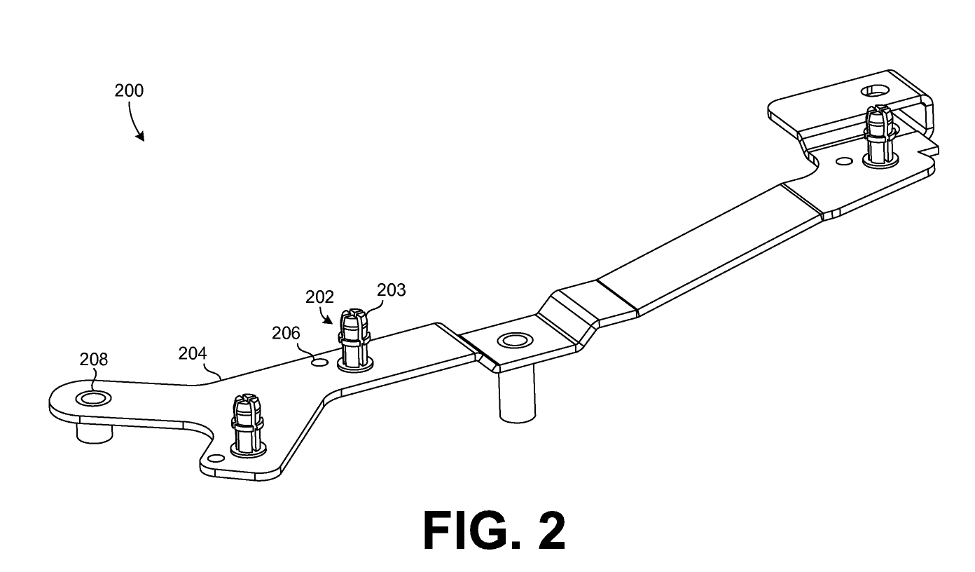

The high frequency cable restraint device 100, shown in FIG. 1, comprises a base portion 102, a top portion 104 and a flexible insert 106. The device 100 is mounted on a device base 200 shown in FIG. 2. The device base 200 features one or more mounting posts 202, to mount the device 100 to the device base 200. The one or more mounting posts 202 are secured to the base plate 204. The base portion 102 of the device 100 fits over the mounting post 202 and the top portion 104 mounts to the mounting post 202, restraining the cable restraint device 100 to the device base 200.

The mounting posts 202 may be a stud featuring a flared end 203 that engages with and retains the restraint device 100. Disposed in a pattern, multiple mounting posts positioned along the base plate 204 lay out a trace for the cables to follow. The pre-laid trace pattern assists in ensuring that the curve radii are sufficient to prevent damage to the cable while routed it is over a substrate, such as being routed through the housing of test equipment.

In the embodiment of the device base 200 shown in FIG. 2, the base plate 204 and the mounting posts 202 are preferably made of metal. The mounting posts 202 are individual components that are affixed to the base plate 204 to form the device base 200. In the example shown, the mounting posts 202 are riveted to the base plate 204. Alternatively, the mounting posts 202 can be affixed to the base plate 204 using other fasteners, such as nut and bolt, adhesive, welding or soldering. The device base 200, including the mounting posts 202 and the base plate 204, can be formed as a single unit by casting, machining or other methods.

Both the base plate 204 and mounting post 202 may be made of any other suitable materials. Such materials include plastics, composites or ceramics. The use of other materials can be considered when taking into consideration the environment in which the cables will be placed. Insulative materials, such as plastic, can be used to electrically isolate the cables. Additional considerations such as cost and manufacturability can also be considered when selecting the material.

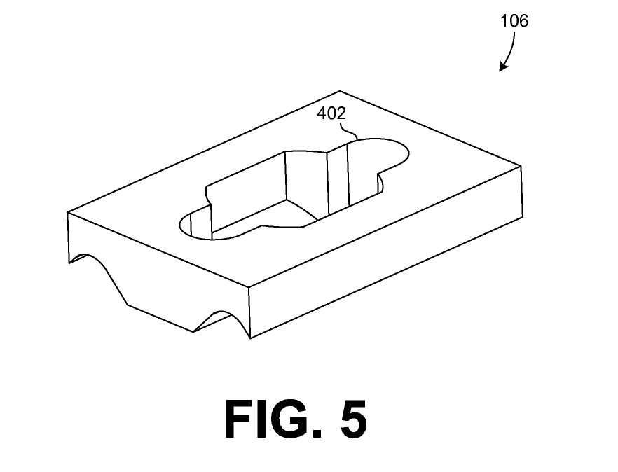

Locating holes 206 are disposed near the mounting posts 202 positions on the base plate 204. The locating holes 206 receive and engage the protrusions 308 on the base portions 102, as seen in FIG. 4 and discussed in more detail below. The engagement of the protrusions 308 and locating holes 206 assist in maintaining the orientation of the restraint devices 100 along the length of the device base 200.

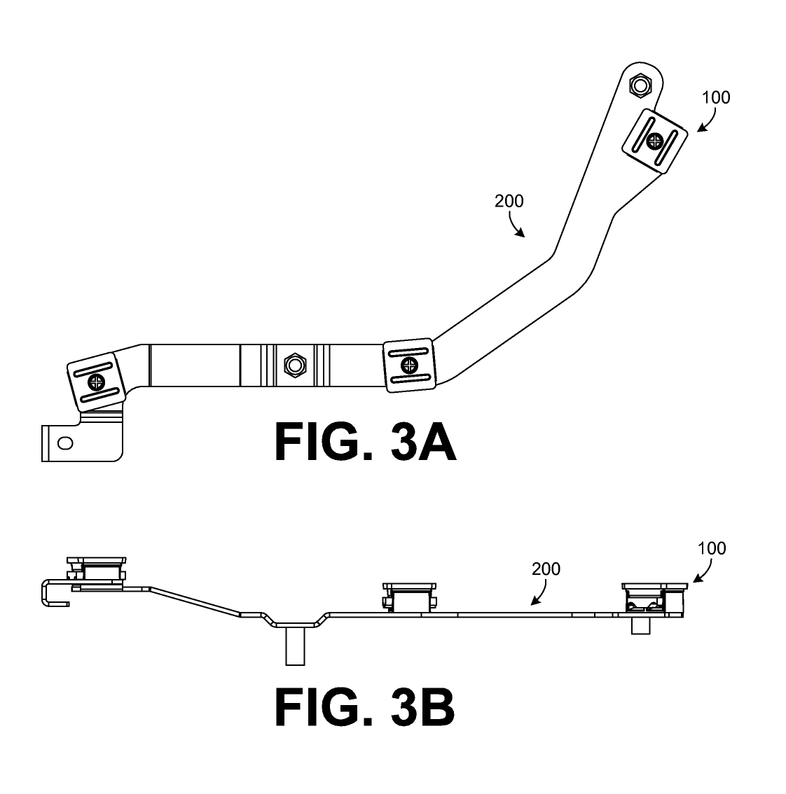

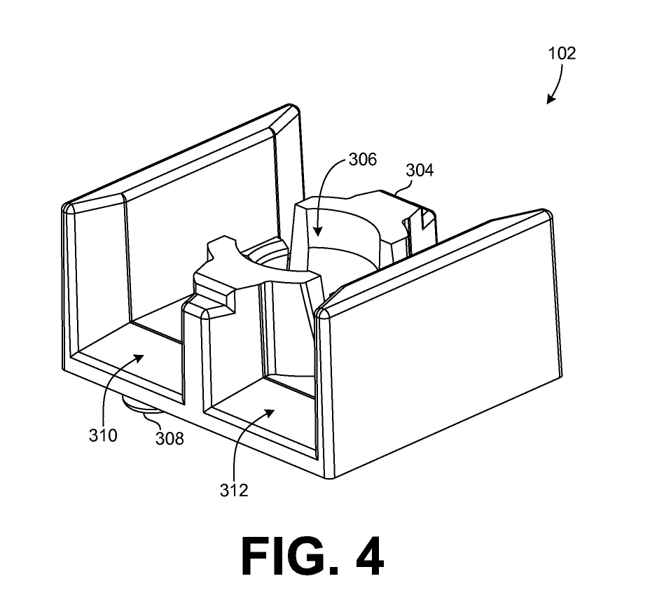

The base plate 204 further features holes 208 disposed along its length through which the device base 200 may be mounted to supports or a substrate 210, as shown in FIGS. 3A and 3B. Alternatively, the device base 200 may be affixed in place using an adhesive or any other suitable attachment means.

The base portion 102 of the device 100, as shown in FIG. 4, is preferably constructed of plastic using an injection moulding process. Alternatively, the base 102 can be made of other suitable materials, such as a ceramic, metallic, rubber or other plastic material.

A central mounting column 304, having a central mounting hole 306, is disposed approximately in the center of the base portion 102. The mounting column 304 receives and slides over the mounting post 202 through the mounting hole 306. The mounting column 304 is structured to engage with a flared portion 203 of the mounting post 202. The flared portion lightly restrains the base 102 to the device base 200. Alternatively, the mounting column 304 may have a friction fit with the mounting post 202 to restrain the base 102. In another embodiment, the mounting column 304 may slide loosely over the mounting post 202 and not actively engage with the one or more mounting posts 202. In a further embodiment, the mounting column 304 can feature internal fins that engage with the mounting post 202. These fins can be deformed, elastically or plastically, such that they exert a pressure on the mounting post 202, restraining the base 102 to the mounting post 202.

In an alternative embodiment, the base 102 may be retained in a position by an adhesive. The adhesive, such as glue, can be placed in the location, with the base 102 then being affixed. Alternatively, the base 102 may have an adhesive layer disposed on the underside of the bottom portion 204. A protective sheet covers the adhesive and when removed the adhesive is exposed and the base 102 can be pressed into the desired position.

In a further embodiment, the base 102 may be mounted using a screw or nail. The screw or nail may be driven through the mounting column 304 into a substrate, such as the device base 200 or directly into a housing. The screw or nail can affix the base 102 only or can be driven through the top portion 104, as well, thus securing the entire restraint device 100 to the desired position.

The high frequency cables run through the base 102 in channels 310 and 312. These channels provide guides for the cables as they are run through the base 102. The channels 310 and 312 do not exert any force on the cables and do not engage the cables to restrain them. This prevents undue pressure being exerted on the cables, which can damage them.

The channels 310 and 312 may be lined with cushioning material, such as a rubber or foam, to further protect the cables. The addition of such protection can also help isolate the cables from vibrations which can wear the cables should they rub against the base 102.

Alternatively, the base 102 can feature a flat base, lacking the mounting column 304 and the channels 310 and 312, but featuring the mounting hole 306. The base 102 slides over the mounting post 202 through the mounting hole 306. An insert can then be slid over the mounting post 202. The insert can feature a mounting column to space the base 102 and the top portion 104 and a central portion that creates channels by dividing the base 102.

The base 102 features a protrusion 308 located on a bottom surface. The protrusion 308 engages with a hole 206 in the base plate 204 of the device base 200, as mentioned above. The hole 206 locates and orients the base 102 on the device base 200. With the protrusion 308 engaged with the hole 206, the base 102 is prevented from rotating about the mounting post 202.

In an embodiment, ridges or protrusions formed on the upper portion of the sidewalls of the base 102 engage with the top portion 104. When the top portion 104 is pressed into the base 102, the two pieces engage and lock together forming the restraint device 100.

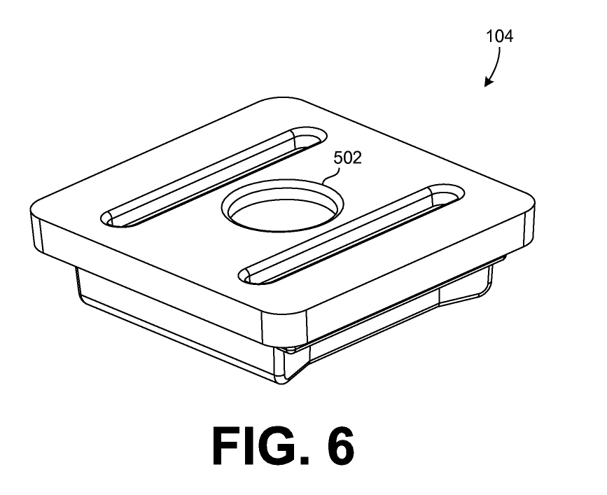

A flexible insert 106, as shown in FIG. 5, is disposed atop the cables running through the base 102. The flexible insert 106 is sized to fit within the base 102 and features a slit 402 that allows the pad to slide over and around the mounting column 304. The flexible insert 106 is space-filling between the cables, base 102 and top portion 104. While the flexible insert 106 is compressed by the top portion 104, the pressure exerted on the wires through the flexible insert 106 is minimal and below the damage threshold. The slight pressure exerted by the flexible insert 106 on the wires prevents them from slipping or sliding through the restraint device 100. In preventing this, undue damage to the cable wrapping and/or the cable itself can be prevented. Additionally, the slight pressure assists in ensuring that a steady or constant tension can be maintained on the cables as desired or necessary to ensure proper cable performance.

The flexible insert 106 may be composed of a number of suitable materials, such as rubber, latex, high and low density foam, or any other polymer. The flexible insert 106 material is selected to evenly distribute and minimize the force exerted on the cables from the closure of the top portion 104 to the base 102.

The flexible insert 106 may be sculpted to further contour to the cables. Contouring the flexible insert 106 lessens the amount of pressure exerted on the cables and further distribute the exerted force evenly.

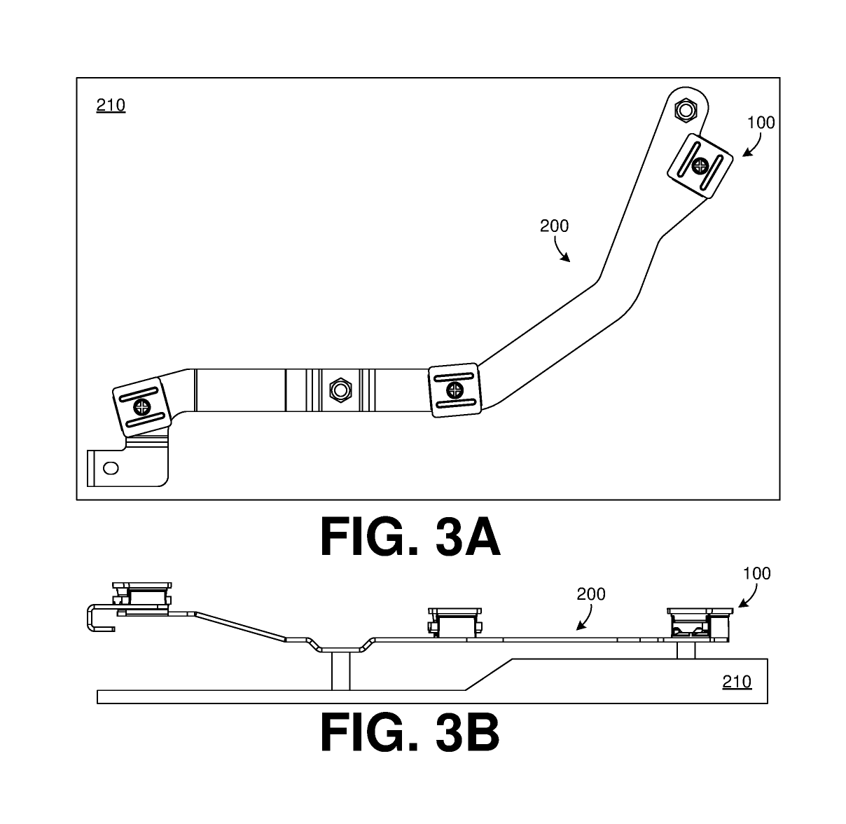

FIG. 6 illustrates an embodiment of the top portion 104 of the device 100. The top portion 104 covers the base 102, the flexible insert 106 and features a central hole 502. When locked to the base 102, by the mounting column 202 engagement with the central hole 502, the top portion 104 lightly compresses the flexible insert 106, exerting a pressure on the cables. The pressure is low enough to not damage the cables but is sufficient to slightly restrain the cables from sliding through the restraint device 100.

To retain the top portion 104 to the base 102, the mounting column 202 of the device base 200 has a flared end 203 that engages the central hole 502 of the top portion 104. The engagement between the central hole 502 and the mounting column 202 is a friction fit sufficient to lock the top portion 104 to the mounting column 202. The friction fit can be overcome by a user so that access can be gained to the cables running internal through the restrain device 100. Additionally, a “click” type friction fit allows the device 100 to be opened and closed repeatedly and reused if so desired.

In an alternate embodiment, as discussed above, a screw or other fastener can be used to affix the device 100. The fastener is driven through the central hole 502 of the top portion 104, through the central column 304 of the base 102 and into a substrate to affix the device in a desired location. Alternatively, the base 102 can be affixed in a position using an attachment means, with the top portion 104 attached to the base 102 by a fastener.

In another embodiment, the flexible insert 106 may be integrated with the top portion 104. This eliminates placing the flexible insert 106 in the device 100 before placing the top portion 104.

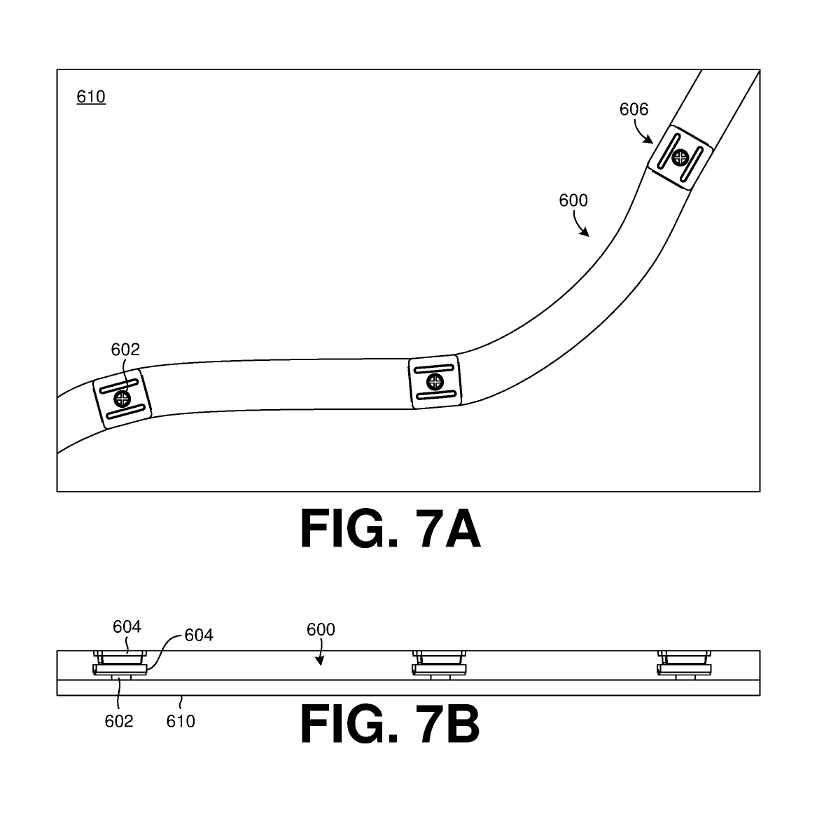

Further means of attaching the top portion 104 on the base 102 may include using an adhesive. The top portion 104 may be glued or sealed onto the base 102 to prevent access to the cables, which may be desirable in some situations. The top portion 104 may also be taped to the base 102. Laying tape across the top portion 104 additionally provides a tamper indication whereby a person attempting to access the cables within the restraint device 100 would have to break the tape seal. The broken tape provides an indication to service technicians or users that a person may have interacted with the restrained cables, thereby potentially damaging them. In an alternative embodiment of the restraint device, the entire device may be integrated with the substrate, as shown in FIGS. 7A and 7B. A channel 600 through which the cables are routed is disposed on or within the substrate 610. The channel features mounting posts 602 disposed along the length. Top pieces 606 engage with the mounting posts 602, as in the previous embodiments, to restrain the cables within the channel 600. A flexible insert 604 is disposed between the cables and each of the top pieces.

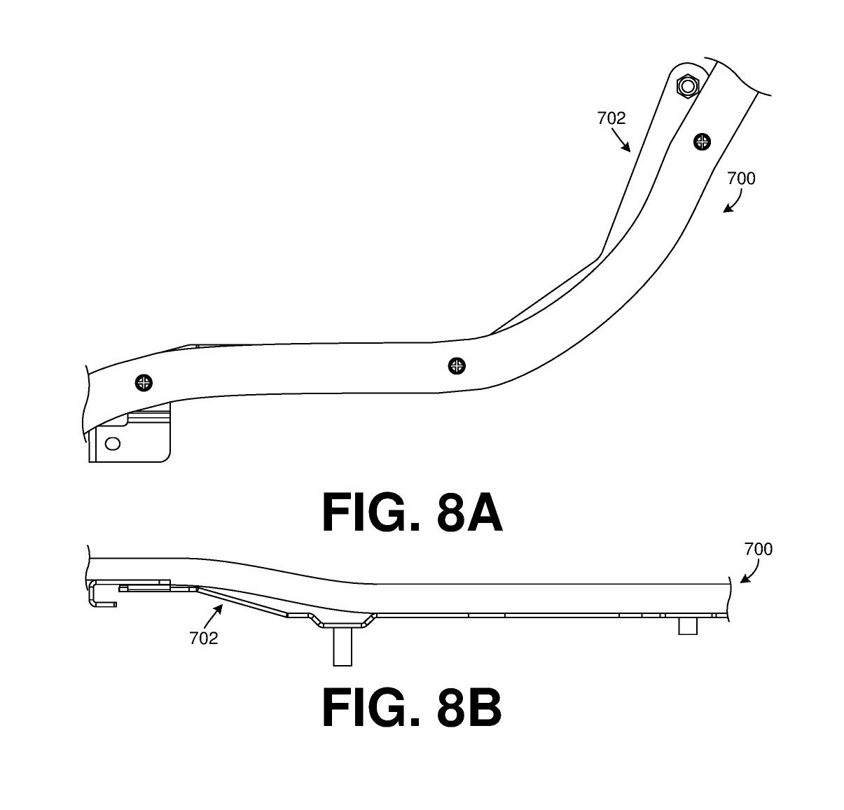

Alternatively, a single top piece may be disposed across the whole length of the channel. The full-length top piece also has a flexible insert disposed between it and the cables to restrain them. An entire cable restraint device 700 can also be disposed across the device base 702, as shown in FIGS. 8A and 8B.

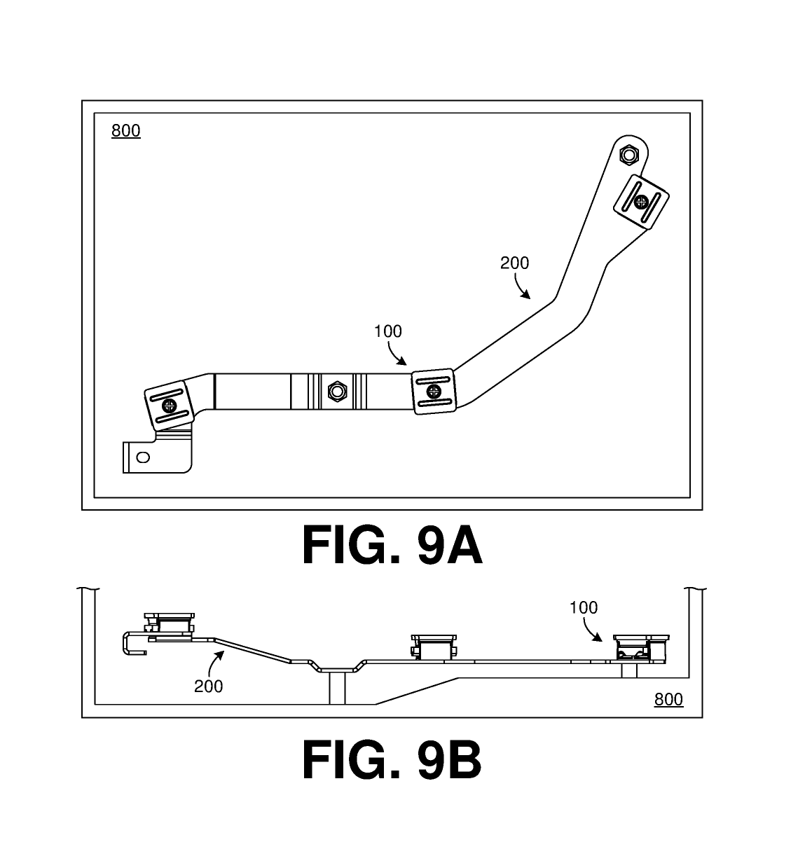

FIGS. 9A and 9B show the cable restraint device 100 and the device base 200 mounted within a housing 800.

To use the cable restraint device 100, the base 102 is first placed over the mounting post 202 disposed on a base plate 204 of the device base 200. The protrusion 308 of the base 102 engages the locating hole 206 on the base plate 204. The engagement of the locating hole 206 and protrusion 308 combined with the engagement between the mounting post 202 and mounting column 304 moderately restrain the base 102 to the device base 200. The cables are placed in the channels, 310 and 312, and then the flexible insert 106 is placed over them. With the flexible insert 106 in place, the top portion 104 is secured to the mounting post 202 thereby completing the restraint device 100 and locking the device 100 firmly to the device base 200.

Having described and illustrated the principles of the disclosed technology in a preferred embodiment thereof, it should be apparent that the disclosed technology can be modified in arrangement and detail without departing from such principles. We claim all modifications and variations coming within the spirit and scope of the following claims.

What is claimed is:

1. A cable restraint system, comprising:
a device base, including:
a base plate, and
at least one mounting post disposed thereon; and
a cable restraint device, including:
a base portion having at least one mounting column structured to receive the at least one mounting post, a pair of opposed sidewalls defining a trough structured to receive at least one cable,
a flexible insert received in the base portion and disposed between the sidewalls, and
a top portion spanning the sidewalk to retain the flexible insert within the base portion and structured to engage the at least one mounting post.

2. The cable restraint system of claim 1, further comprising at least one locating hole disposed on the base plate and proximate to the at least one mounting post.

3. The cable restraint system of claim 2, wherein the base portion of the cable restraint device further includes a protrusion disposed on a lower surface and structured to engage the at least one locating hole.

4. The cable restrain system of claim 1, wherein the top portion features an opening structured to engage the at least one mounting post, the engagement releasably securing the top portion to the at least one mounting post.

5. The cable restraint system of claim 4, wherein the at least one mounting post features a flared end structured to engage with the opening of the top portion.

6. The cable restraint system of claim 1, wherein the device base is attached to a substrate.

7. (canceled)

8. The cable restraint system of claim 1, wherein the base portion of the cable restraint device includes at least one channel disposed on a lower surface of the trough, the at least one channel structured to receive a cable.

9. The cable restraint system of claim 1, wherein the flexible insert is composed of a polymer.

10. The cable restraint system of claim 1, wherein the flexible insert has a contoured profile.

11. The cable restraint system of claim 1, wherein the top portion includes a central opening.

12. The cable restraint system of claim 1, wherein the top portion is structured to engage with the base portion of the cable restraint device.

13. The cable restraint system of claim 1, wherein the cable restraint device is disposed along an entire length of the device base.

14. The cable restraint system of claim 1, wherein a plurality of cable restraint devices are disposed along the device base.

15. The cable restraint system of claim 1, further including a housing, wherein the device base portion and the cable restraint device are structured to be mounted in the housing.

16. A cable restraint system, comprising:
a substrate, including:
a channel, and
at least one mounting post disposed therein; and
a cable restraint device, including:
a base portion having at least one mounting column structured to receive the at least one mounting post, a pair of opposed sidewalls defining a trough structured to receive at least one cable,
a flexible insert received in the base portion and disposed between the sidewalls, and
a top portion spanning the sidewalls to retain the flexible insert within the base portion and structured to engage the at least one mounting post.
